(19) United States
(12) Patent Application Publication
(10) Pub. No.: US 2009/0324877 A1
(43) Pub. Date: Dec. 31, 2009

(54) HOUSING AND METHOD FOR FABRICATING THE SAME

(75) Inventors: CHENG-WEN SU, Shindian (TW); GANG HUANG, Shenzhen City (CN); ZHONG-DAN DENG, Shenzhen City (CN); YIN-JIE GUO, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (Hong Kong) Limited, Kowloon (HK)

(21) Appl. No.: 12/471,548

(22) Filed: May 26, 2009

(30) Foreign Application Priority Data
Jun. 27, 2008 (CN) 200810302409.3

(51) Int. Cl. B32B 7/04; B29C 39/12

(52) U.S. Cl. 428/111; 264/250; 428/223; 428/161

(57) ABSTRACT

A housing includes a base layer, a cover layer and an embedding member, the base layer is formed in a first molding, the cover layer is formed in a second molding, the embedding member is between the base layer and the cover layer, the base layer has locking members formed thereon in the first molding, the embedding member is firmly latched with the locking members in the second molding. A method for fabricating the housing is also described.

### BACKGROUND

1. Technical Field

The present disclosure relates to housings and a method for fabricating the same.

2. Description of Related Art

To improve the aesthetic appearance of a housing of an electronic device, the housing is typically embedded with a decorating member by insert molding. During molding, the decorating member is positioned inside a mold and then integrated with injected molten plastic to produce the housing.

The decorating member needs to be accurately positioned in the mold. However, the decorating member is difficult to keep in place or undistorted under the impulsive force of the injected molten plastic. A moved and/or distorted decorating member will directly degrade the aesthetic appearance of the housing.

Therefore, there is room for improvement within the art..

### BRIEF DESCRIPTION OF THE DRAWINGS

Many aspects of the new housing and method for fabricating the same can be better understood with reference to the following drawings. The components in the drawings are not necessarily drawn to scale, the emphasis instead being placed upon clearly illustrating the principles of the new housing and method for fabricating the same. Moreover, in the drawings, like reference numerals designate corresponding parts throughout the several views.

FIG. 1 is an isometric view of an integrated housing according to an exemplary embodiment including a base layer, an embedding member and a cover layer.

FIG. 2 is an exploded view of the housing shown in FIG. 1.

FIG. 3 is a schematic view of a mold at an opened state for molding the housing shown in FIG. 1.

FIG. 4 is a schematic view of a mold at a closed state to FIG. 3.

FIG. 5 is a planar view of the embedding member secured to the base layer.

### DETAILED DESCRIPTION OF THE EMBODIMENT

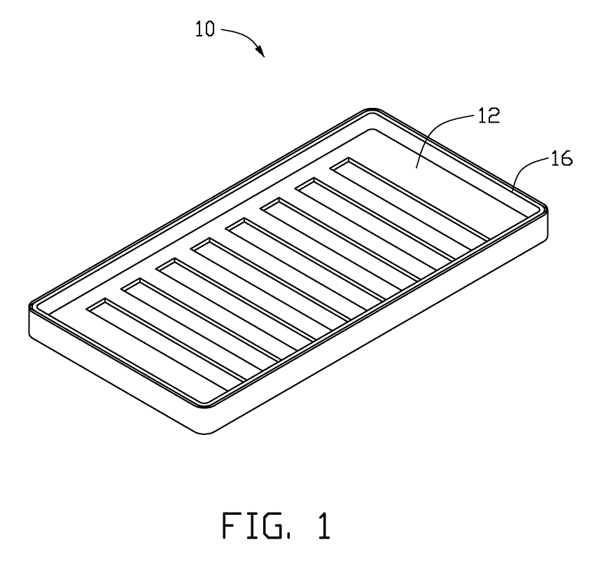

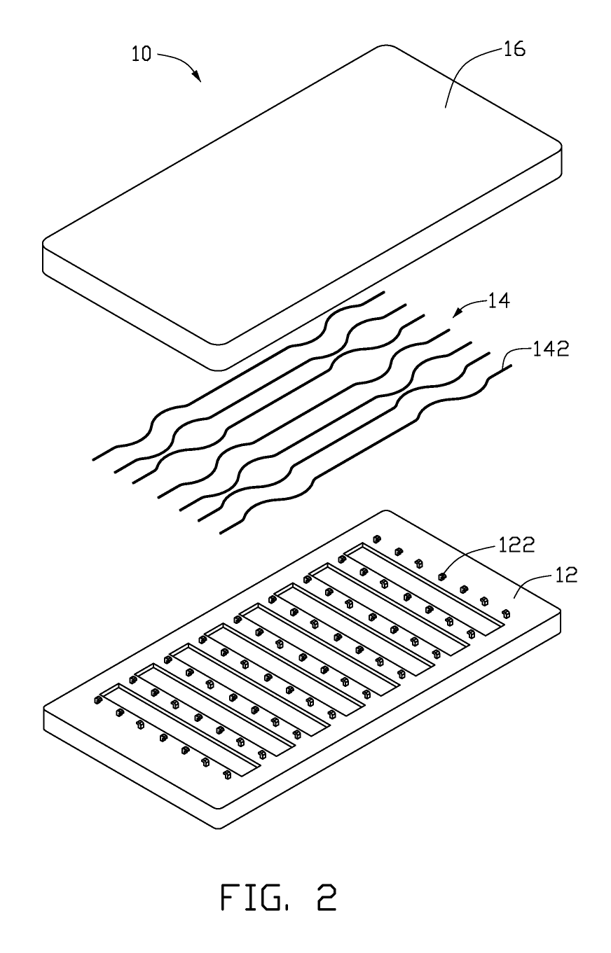

FIG. 1 and FIG. 2 show an exemplary housing 10 used for portable electronic devices, such as mobile phones.

The housing 10 includes a base layer 12, an embedding member 14, and a cover layer 16 to cover the base layer 12. The base layer 12 can be made of a first plastic material chosen from a group consisting of polythene, polypropylene, polyvinyl chloride (PVC), and acrylonitrile-butadiene-styrene (ABS), or any desired combination thereof. The cover layer 16 can be made of a second plastic material chosen from a group consisting of polystyrene, polycarbonate (PC), and polymethyl methacrylate (PMMA), or any desired combination thereof. The base layer 12 has a plurality of locking members 122 formed thereon for securing the embedding member 14. The embedding member 14 is located between the base layer 12 and the cover layer 16. The embedding member 14 includes a plurality of decorative wires 142 for latching with the locking members 122.

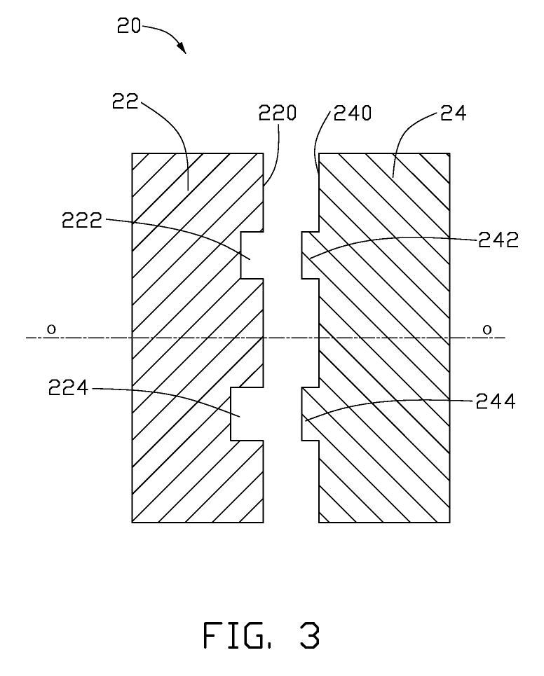

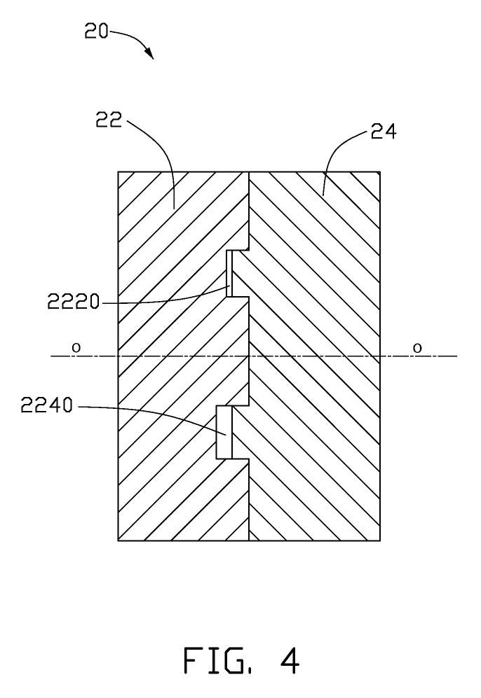

Referring to FIG. 3 and FIG. 4, the housing 10 is fabricated using a dual-injection mold 20. The mold 20 includes a female molding plate 22 and a male molding plate 24. The female molding plate 22 includes a first molding surface 220, which defines a first molding cavity 222 and a second molding cavity 224. The second molding cavity 224 is deeper than the first molding cavity 222. The first molding cavity 222 can have impression in a surface thereof to form the locking members 122 when molten plastic is poured therein. The male molding plate 24 includes a second molding surface 240, the second molding surface 240 forms a first molding core 242 and a second molding core 244 of equal height. The mold 20 further has a central axis O-O, and the male molding plate 24 can rotate around the axis O-O. The first and second molding cores 242, 244 can each engage with either of the first and second molding cavities 222, 224.

To mold the housing 10, the male molding plate 24 is closed to the female molding plate 22, and the first molding core 242 engages in the first molding cavity 222 and thus defines a first chamber 2220 therebetween. In the same manner, a second chamber 2240 is defined by engagement of the second molding core 244 in the second molding cavity 224. By injecting the molten first plastic materials into the first chamber 2220, the base layer 12 is formed with the locking members 122, and the locking members 122 are arranged evenly in a matrix shape. It is to be understood that the locking members 122 can be arranged as needed when making the impressions in the first molding cavity 222. After separation of the male molding plate 24 from the female molding plate 22, the base layer 12 remains attached on the first molding core 242.

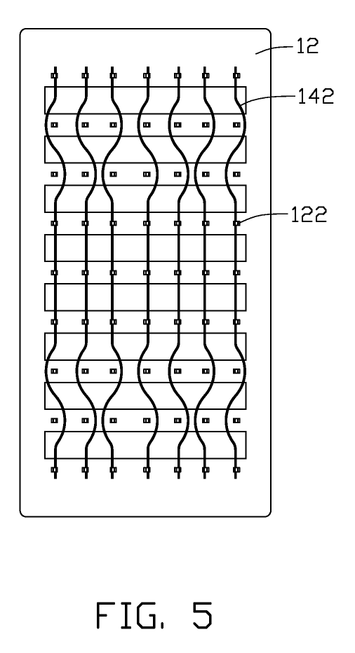

After that, referring to FIG. 5, the decorative wires 142 can be latched to the locking members 122. Then, rotating the male molding plate 24 around the axes 0-0 and closing the male molding plate 24 to the female molding plate 22, the first molding core 242 engages in the second molding cavity 224 to define a third chamber (not shown).

Injection of the molten second plastic materials into the third chamber integrally combines the cover layer 16 with the base layer 12. The embedding member 14 is embedded between the base layer 12 and the cover layer 16.

The second molding core 244 engaging into the first molding cavity 222 defines a fourth chamber (not shown) for forming the base layer 12 in the same manner discussed in [0014].

As disclosed above, the housing 10 is dual-molded. After the first molding, the base layer 12 is attached on the first molding core 242. The embedding member 14 is secured to the locking members 122 attached on the first molding core 242, which maintains the embedding member 14 positioned accurately, un-movable and un-distorted in the third molding cavity for molding the housing 10.

It is to be understood, when the decorative wires 142 of the embedding member 14 are adjacent to the cover layer 16, due to the housing 10 has a certain contractibility after molding, the embedding member 14 will protrude and turn on the profile on the cover layer 16.

1. A housing, comprising:
a base layer formed in a first molding;
a cover layer formed in a second molding; and
an embedding member located between the base layer and the cover layer, the base layer forming locking members in the first molding, the embedding member firmly latched with the locking members when molding the cover layer in the second molding.

2. The housing as claimed in claim 1, wherein the base layer is made any of materials chosen from a group consisting of polythene, polypropylene, polyvinyl chloride (PVC), and acrylonitrile-butadiene-styrene, or any desired combination thereof.

3. The housing as claimed in claim 1, wherein the cover layer is made any of materials chosen from a group consisting of polystyrene, polycarbonate (PC), and polymethyl methacrylate (PMMA), or any desired combination thereof.

4. The housing as claimed in claim 1, wherein the base layer and the cover layer are made of transparent plastic, and the embedding member includes decorative wires.

5. The housing as claimed in claim 1, wherein the locking members are formed in the base layer and arranged in a matrix shape.

6. A method for fabricating a housing, including:
molding a base layer in a first molding, and the base layer having locking members formed thereon;
providing an embedding member and placing the embedding member to the base layer, the embedding member being latched with the locking members;
molding a cover layer in a second molding, the cover layer combining the base layer and the embedding member being embedded between the cover layer and the base layer.

7. The method as claimed in claim 6, wherein the base layer is made of first plastic materials, the cover layer is made of second plastic materials.

8. The method as claimed in claim 6, wherein the base layer and the cover layer are made of transparent plastic, the embedding member includes decorative wires.

9. The method as claimed in claim 6, wherein the mold for fabricating the housing includes a male molding plate and a female plate, the male molding plate forms a first molding core and a second molding core thereon, the female molding plate defines a first molding cavity and a second molding cavity thereon, the first and second molding cores can each engage with either of the first and second molding cavities.

10. The method as claimed in claim 9, wherein the second molding cavity is deeper than the first molding cavity, the first molding core and the second molding core have equal height.

11. A housing, comprising:
a base layer;
a cover layer; and
an embedding member located between the base layer and the cover layer, the base layer formed in a first molding and having locking members formed thereon, the cover being formed in a second molding, the embedding member firmly latched with the locking members when molding the cover layer in the second molding.

12. The housing as claimed in claim 11, wherein the base layer is made of transparent plastic with the cover layer, the embedding member includes decorative wires and forms a profile on the cover layer.
